(19) United States
(12) Patent Application Publication
(10) Pub. No.: US 2007/0006442 A1
(43) Pub. Date: Jan. 11, 2007

(54) Stamping process and structure of anti-magnetic cover

(75) Inventor: Kuo-Wei Liang, Taipei (TW)

Correspondence Address: BACON & THOMAS, PLLC, 625 SLATERS LANE, FOURTH FLOOR, ALEXANDRIA, VA, 22314, US

(73) Assignee: XIERTEK INDUSTRIAL CO., LTD., TAIPEI HSIEN (TW)

(21) Appl. No.: 11/172,832

(22) Filed: Jul. 5, 2005

(51) Int. Cl. B23P 11/00; B21D 39/00

(52) U.S. Cl. 29/513; 29/505; 29/509; 29/514

(57) ABSTRACT

The present invention is improving stamping process and structure of anti-magnetic cover. The said anti-magnetic cover is laid over electronic component for preventing the interference of electromagnetic wave. During stamping the said anti-magnetic cover, two plate materials are fed into one cavity from different directions. After stamping process, a frame and an upper cover are formed, where around the frame female latching parts are formed and around the corresponding positions on the upper cover male latching parts are formed. The design of male and female parts makes it easier to disassemble as well as to maintain the upper cover and thus avoid the necessity of exchanging the anti-magnetic cover.

### BACKGROUND OF THE INVENTION

(a) Field of the Invention

The present invention relates to the improvement on structure of magnet-shielded device, specifically, device assembled on the circuit board for shielding specified electronic devices in order either to keep the shielded electronic devices away from the interference of electromagnetic wave or static electricity, or to isolate other neighboring electronic components from the electromagnetic wave generated by the said electronic component.

(b) Description of the Prior Art

With the advance of density in integrated circuits, electromagnetic interference between various electronic components has become a serious problem. For a chip with powerful operation performance, the high frequency environment caused during operation inevitably exerts electromagnetic interference to other electronic components, thus influences the stability and lifetime of electronic products.

To solve the deficiency described above, the existing solution is to install an upside-down U-shaped metal shield, which is named anti-magnetic cover, on specified electronic component such that the said electronic component is shielded. The interference caused by electromagnetic wave or static electricity generated from electronic component or outside world is therefore isolated.

Conventionally, there are three methods to fix an anti-magnetic cover on a circuit board: the first is to fix the cover by latching to the circuit board, the second is to fix by locking the cover, the third is to weld the surroundings of metal anti-magnetic cover to the edge of region that anti-magnetic cover connected to the circuit board. All of these three methods fix anti-magnetic cover to a circuit board to shield specified electronic component and isolate the interference of electromagnetic wave or static electricity.

However, the method of fixing by latch described above has to drill holes on the circuit board for fixing, which not only destructs the circuit board but also, taking account of miniaturization, hinder the layout on the circuit board. In the other aspect, although the method of fixing by locking is beneficial for assembling and disassembling the anti-magnetic cover, the assembling cost (i.e., cost of man-power) of this method is comparatively high, and artificial operations necessarily influence the precision and yield of products. With regard to the method of fixing by welding, it is the most acceptable processing method by the manufacturers because welding can be performed automatically and the anti-magnetic cover can be fixed steadily after welded. However, this method is unfavorable to personnel of maintenance because special tools are needed during maintenance. Also, to remove the anti-magnetic cover, more time is needed while rendering the welded solders down one by one. Another problem caused by the third method is that, during maintenance, incautious operations may short-circuit other integrated-circuit components.

Therefore, the manufacturers of anti-magnetic cover all try to find a method that can concisely and efficiently assemble anti-magnetic cover during manufacturing while take the disassembling problem during follow-up maintenance into account.

### SUMMARY OF THE INVENTION

The primary purpose of the present invention is to provide an anti-magnetic cover that contains a frame and an upper cover where, utilizing the merit of welding, the frame is welded on the circuit board. Then the upper cover is assembled to the frame by way of latching. The anti-magnetic cover is consequently firmly installed and the maintenance problem is accordingly taken into account.

The secondary purpose of the present invention is to provide an anti-magnetic cover that contains a frame and an upper cover, where, the plate materials of frame and upper cove are respectively fed from different directions into the cavity of the same mold. After stamping process, the upper cover and frame are formed simultaneously. The stability of forming and processing in the same environment is thus considered, and the stages of forming and processing are accordingly simplified.

Therefore, the present invention for improving stamping process and structure of anti-magnetic cover not only considers the steadiness during assembling, but also thinks about the problem during follow-up maintenance, which have entirely corresponded to the necessary conditions for patent pending. The technical matters and the detail explanation of the present invention together with the accompanying drawings are described in the following:

### BRIEF DESCRIPTION OF THE DRAWINGS

FIG. 1 shows a pictorial drawing according to the present invention.

FIG. 2 shows an exploded view according to the present invention.

FIG. 3 is a pictorial drawing showing the operation of disassembling the upper cover according to the present invention.

FIG. 4 is a pictorial drawing showing the stamping process according to the present invention.

FIG. 5 shows an exploded view from another viewpoint according to the present invention.

### DETAILED DESCRIPTION OF THE PREFERRED EMBODIMENTS

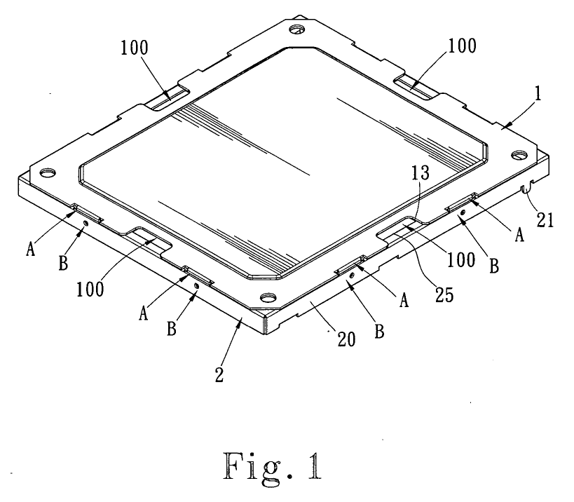

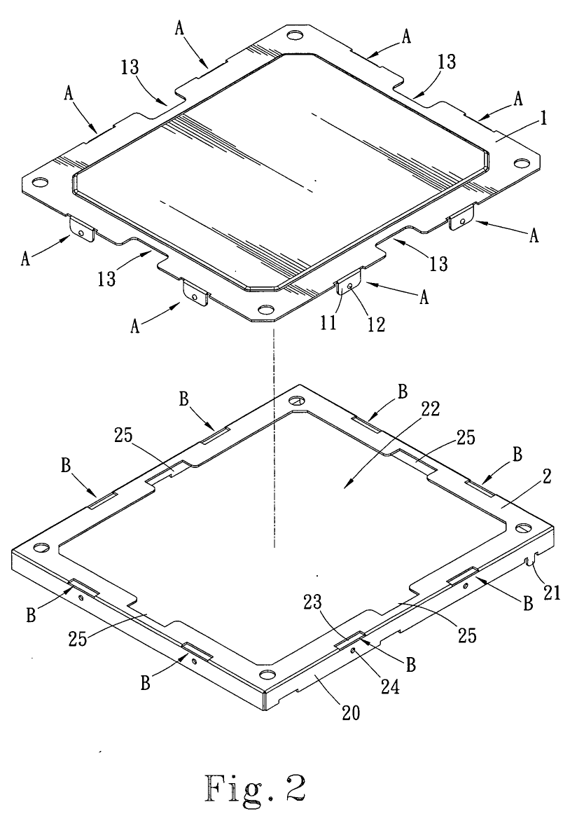

Referring to FIG. 1 and 2, in which the anti-magnetic cover according to the invention includes a frame 2 and an upper cover 1, where male latching parts A are separately formed around the upper cover 1, concaves 13 are provided between male latching parts A, where the male latching part A include an L-shaped bend tenon 11 and convex part 12 formed on the tenon 11.

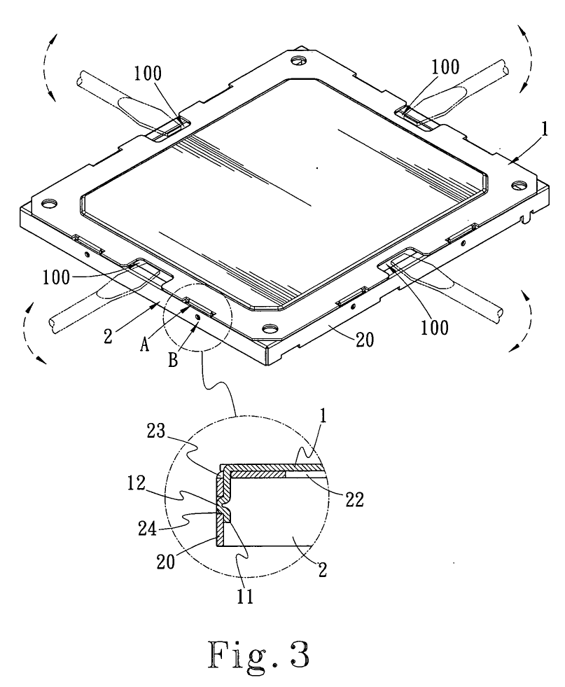

Further, the said frame is an upside-down U-shaped border 20. At the lower edge of border 20 welding pins 21 are provided for welding on the circuit board. At the top center of frame 2 a hollow 22 is formed to correspond to the shielded electronic components, and female latching parts B are provided around the hollow 22 in order to be latched by the male latching parts A. Concaves 25 are provided between female latching parts B and correspond to the concaves 13 of the upper cover 1. When upper cover 1 is assembled to frame 2, gaps 100 are formed. During maintenance, inserting a tool into the gap 100 and levering upward can separate the upper cover 1 and frame 2 (as shown in FIG. 3). Moreover, the female latching parts B include a via 23 and a positioning hole 24, where the via 23 is provided for embedding tenon 11 of upper cover 1. On the border 20, corresponding to each slot, positioning holes 24 are provided. During assembling the upper cover 1, the positioning hole 24 will correspond to the convex part 12 on the tenon 11 and forms latch-up status (as shown in FIG. 3). By way of the structural design of male latching parts A on the upper cover 1 and female latching parts B on the frame 2, the upper cover 1 can be easily disassembled for maintenance. The anti-magnetic cover can thus be assembled without restrain.

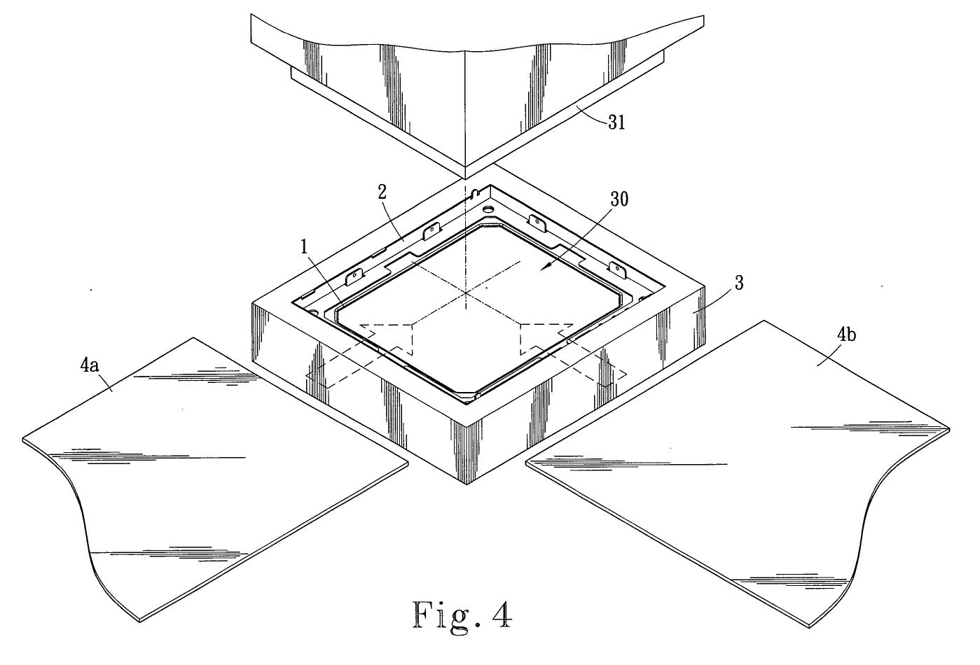

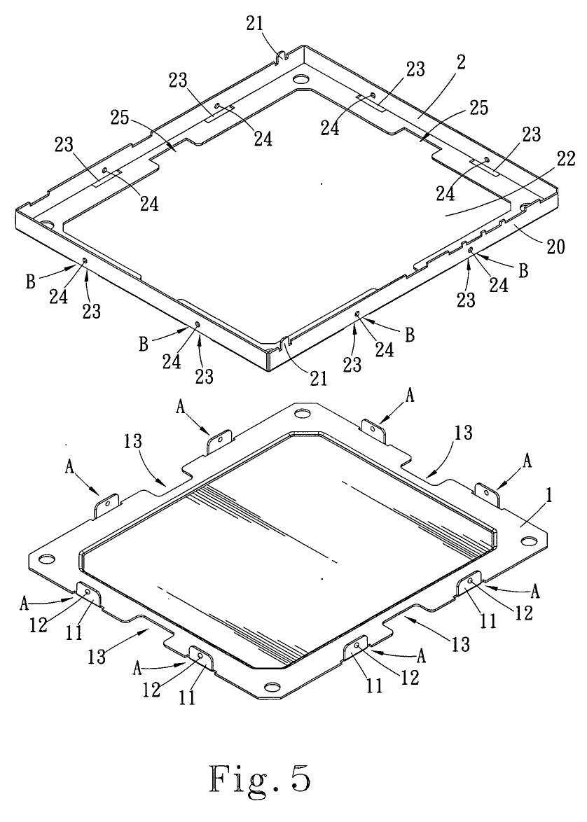

Referring to FIG. 4 and 5, in which the anti-magnetic cover according to the present invention includes a frame 2 and an upper cover 1. During stamping process, the plate materials 4A, 4B of frame and upper cove are respectively fed from different directions into the cavity 30 of the same mold 3. Through the punching of stamping die 31, the upper cover 1 and the frame 2 can be formed simultaneously. As the upper cover 1 and the frame 2 are formed under the same processing environment and are formed simultaneously, the steadiness of forming the whole anti-magnetic cover is accordingly promoted, and the stages for processing are consequently simplified.

Furthermore, the improvement on stamping process and structure of anti-magnetic cover according to the present invention not only utilizes the welding pins 21 on the border 20 of frame 2 to effectively fix the whole anti-magnetic cover on the circuit board, but also provides a structural design of male and female latching parts A, B between the upper cover 1 and the frame 2, such that the problem of follow-up maintenance is taken into account, which indeed avoids the deficiencies of the conventional methods.

What is claimed is:

1. An improvement on stamping process and structure of anti-magnetic cover, the said anti-magnetic cover includes a frame and an upper cover, through the latching between the male and the female latching part on upper cover and frame, the upper cover can be easily disassembled from the frame, where:
the said upper cover is a plate of metal material, one or more than one male latching part is formed around the upper cover, and concaves are provided between male latching parts;
the said frame is a border of metal material, where welding pins are provided around the lower edge of the border, female latching parts with amount corresponding to that of male latching parts are provided around the border, and concaves are provided between female latching parts,
such that, during stamping and forming, the original plate materials are fed into a cavity of the same mold from different directions, and the frame as well as the upper cover are formed simultaneously, in which the same processing environment and the simplification of processing stages are considered.

2. An improvement on stamping process and structure of anti-magnetic cover in accordance with claim 1, wherein the male latching part on the upper cover can be embodied by providing a convex part on a tenon.

3. An improvement on stamping process and structure of anti-magnetic cover in accordance with claim 1, wherein the female latching part on the upper cover can be embodied by providing a via and forming a positioning hole on the corresponding lengthwise border.

4. An improvement on stamping process and structure of anti-magnetic cover in accordance with claim 1, wherein the concaves on the upper cover and the frame are correspondent, and gaps are formed after assembling the upper cover and the frame for accepting the insertion of maintaining tool.
